(19) United States
(12) Patent Application Publication
(10) Pub. No.: US 2002/0077823 A1
(43) Pub. Date: Jun. 20, 2002

(54) Software development systems and methods

(76) Inventors: Andrew Fox, Sudbury, MA (US); Bin Liu, Northborough, MA (US); Michael Tinglof, Concord, MA (US); Tim F. Rochford, East Greenwich, RI (US); Toffee A. Albina, Cambridge, MA (US); Lorin Wilde, Stoneham, MA (US); Jeffrey M. Hill, Westford, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/822,590

(22) Filed: Mar. 30, 2001

Related U.S. Application Data
(60) Provisional application No. 60/240,292, filed on Oct. 13, 2000.

(51) Int. Cl. G10L 13/08; G10L 13/00

(52) U.S. Cl. 704/260

(57) ABSTRACT

A software development method and apparatus is provided for the simultaneous creation of software applications that operate on a variety of client devices and include text-to-speech and speech recognition capabilities. A software development system and related method use a graphical user interface that provides a software developer with an intuitive drag and drop technique for building software applications. Program elements, accessible with the drag and drop technique, include corresponding markup code that is adapted to operate on the plurality of different client devices. The software developer can generate a natural language grammar by providing typical or example spoken responses. The grammar is automatically enhanced to increase the number of recognizable words or phrases. The example responses provided by the software developer are further used to automatically build application-specific help. At application runtime, a help interface can be triggered to present these illustrative spoken prompts to guide the end user in responding.

### CROSS-REFERENCE TO RELATED CASE

This application claims priority to and the benefit of, and incorporates herein by reference, in its entirety, provisional U.S. patent application Ser. No. 60/240,292, filed Oct. 13, 2000.

### TECHNICAL FIELD

The present invention relates generally to software development systems and methods and, more specifically, to software development systems and methods that facilitate the creation of software and World Wide Web applications that operate on a variety of client platforms and are capable of speech recognition.

### BACKGROUND INFORMATION

There has been a rapid growth in networked computer systems, particularly those providing an end user with an interactive user interface. An example of an interactive computer network is the World Wide Web (hereafter, the “web”). The web is a facility that overlays the Internet and allows end users to browse web pages using a software application known as a web browser or, simply, a “browser.” Example browsers include Internet Explorer™ by Microsoft Corporation of Redmond, Wash., and Netscape Navigator™ by Netscape Communications Corporation of Mountain View, Calif. For ease of use, a browser includes a graphical user interface that it employs to display the content of “web pages.” Web pages are formatted, tree-structured repositories of information. Their content can range from simple text materials to elaborate multimedia presentations.

The web is generally a client-server based computer network. The network includes a number of computers (i.e., “servers”) connected to the Internet. The web pages that an end user will access typically reside on these servers. An end user operating a web browser is a “client” that, via the Internet, transmits a request to a server to access information available on a specific web page identified by a specific address. This specific address is known as the Uniform Resource Locator (“URL”). In response to the end user's request, the server housing the specific web page will transmit (i.e., “download”) a copy of that web page to the end user's web browser for display.

To ensure proper routing of messages between the server and the intended client, the messages are first broken up into data packets. Each data packet receives a destination address according to a protocol. The data packets are reassembled upon receipt by the target computer. A commonly accepted set of protocols for this purpose are the Internet Protocol (hereafter, “IP”) and Transmission Control Protocol (hereafter, “TCP”). IP dictates routing information. TCP dictates how messages are actually separated in to IP packets for transmission for their subsequent collection and reassembly. TCP/IP connections are typically employed to move data across the Internet, regardless of the medium actually used in transmitting the signals.

Any Internet “node” can access a specific web page by invoking the proper communication protocol and specifying the URL. (A “node” is a computer with an IP address, such as a server permanently and continuously connected to the Internet, or a client that has established a connection to a server and received a temporary IP address.) Typically, the URL has the format http://<host>/<path>, where “http” refers to the HyperText Transfer Protocol, “<host>” is the server's Internet identifier, and the “<path>” specifies the location of a file (e.g., the specific web page) within the server.

As technology has evolved, access to the web has been achieved by using small wireless devices, such as a mobile telephone or a personal digital assistant (“PDA”) equipped with a wireless modem. These wireless devices typically include software, similar to a conventional browser, which allows an end user to interact with web sites, such as to access an application. Nevertheless, given their small size (to enhance portability), these devices usually have limited capabilities to display information or allow easy data entry. For example, wireless telephones typically have small, liquid crystal displays that cannot show a large number of characters and may not be capable of rendering graphics. Similarly, a PDA usually does not include a conventional keyboard, thereby making data entry challenging.

An end user with a wireless device benefits from having access to many web sites and applications, particularly those that address the needs of a mobile individual. For example, access to applications that assist with travel or dining reservations allows a mobile individual to create or change plans as conditions change. Unfortunately, many web sites or applications have complicated or sophisticated web pages, or require the end user to enter a large amount of data, or both. Consequently, an end user with a wireless device is typically frustrated in his attempts to interact fully with such web sites or applications.

Compounding this problem are the difficulties that software developers typically have when attempting to design web pages or applications that cooperate with the several browser programs and client platforms in existence. (Such large-scale cooperation is desirable because it ensures the maximum number of end users will have access to, and be able to interact with, the pages or applications.) As the number and variety of wireless devices increases, it is evident that developers will have difficulties ensuring their pages and applications are accessible to, and function with, each. Requiring developers to build separate web pages or applications for each device is inefficient and time consuming. It also complicates maintaining the web pages or applications.

From the foregoing, it is apparent that there is still a need for a way that allows an end user to access and interact with web sites or applications (web-based or otherwise) using devices with limited display and data entry capabilities. Such a method should also promote the efficient design of web sites and applications. This would allow developers to create software that is accessible to, and functional with, a wide variety of client devices without needing to be overly concerned about the programmatic idiosyncrasies of each.

### SUMMARY OF THE INVENTION

The invention relates to software development systems and methods that allow the easy creation of software applications that can operate on a plurality of different client platforms, or that can recognize speech, or both.

The invention provides systems and methods that add speech capabilities to web sites or applications. A text-to-speech engine translates printed matter on, for example, a web page in to spoken words. This allows a user of a small, voice capable, wireless device to receive information present on the web site without regard to the constraints associated with having a small display. A speech recognition system allows a user to interact with web sites or applications using spoken words and phrases instead of a keyboard or other input device. This allows an end user to, for example, enter data into a web page by speaking into a small, voice capable, wireless device (such as a mobile telephone) without being forced to rely on a small or cumbersome keyboard.

The invention also provides systems and methods that allow software developers to author applications (such as web pages, or applications, or both, that can be speech-enabled) that cooperate with several browser programs and client platforms. This is accomplished without requiring the developer to create unique pages or applications for each browser or platform of interest. Rather, the developer creates a single web page or application that is processed according to the invention into multiple objects each having a customized look and feel for each of the particular chosen browsers and platforms. The developer creates one application and the invention simultaneously, and in parallel, generates the necessary runtime application products for operation on a plurality of different client devices and platforms, each potentially using different browsers.

One aspect of the invention features a method for creating a software application that operates on, or is accessible to, a plurality of client platforms, also known as “target devices.” A representation of one or more target devices is displayed on a graphical user interface. As the developer creates the application, a simulation is performed in substantially real time to provide an indication of the appearance of the application on the target devices. The results of this simulation are displayed on the graphical user interface.

To create the application, the developer can access one or more program elements that are displayed in the graphical user interface. Using a “drag and drop” operation, the developer can copy program elements to the application, thereby building a program structure. Each program element includes corresponding markup code that is further adapted to each target device. A voice conversation template can be included with each program element, and each template represents a spoken word equivalent of the program element. The voice conversation template, which the developer can modify, is structured to provide or receive information associated with the program element.

In a related aspect, the invention provides a visual programming apparatus to create a software application that operates on, or is accessible to, a plurality of client platforms. A database that includes information on the platforms or target devices is provided. A developer provides input to the apparatus using a graphical user interface. To create the application, several program elements, with their corresponding markup code, are also provided. A rendering engine communicates with the graphical user interface to display images of target devices selected by the developer. The rendering engine communicates with the target device database to ascertain, for example, device-specific parameters that dictate the appearance of each target device on the graphical user interface. For the program elements selected by the developer, a translator, in communication with the graphical user interface and the target device database, converts the markup code to form appropriate to each target device. As the developer creates the application, a simulator, also in communication with the graphical user interface and the target device database, provides a real time indication of the appearance of the application on one or more target devices.

In another aspect, the invention involves a method of creating a natural language grammar. This grammar is used to provide a speech recognition capability to the application being developed. The creation of the natural language grammar occurs after the developer provides one or more example phrases, which are phrases an end user could utter to provide information to the application. These phrases are modified and expanded, with limited or no required effort on the part of the developer, to increase the number of recognizable inputs or utterances. Variables associated with text in the phrases, and application fields corresponding to the variables, have associated subgrammars. Each subgrammar defines a computation that provides a value for the associated variable.

In a further aspect, the invention features a natural language grammar generator that includes a graphical user interface that responds to input from a user, such a software developer. Also provided is a database that includes subgrammars used in conjunction with the natural language grammar. A normalizer and a generalizer, both in communication with the graphical user interface, operate to increase the scope of the natural language grammar with little or no additional effort on the part of the developer. A parser, in communication with the graphical user interface, operates with a mapping apparatus that communicates with the subgrammar database. This serves to associate a subgrammar with one or more variables present in a developer-provided example user response phrase.

In another aspect, the invention relates to a method of providing speech-based assistance during, for example, application runtime. One or more signals are received. The signals can correspond to one or more DTMF tones. The signals can also correspond to the sound of one or more words spoken by an end user of the application. In this case, the signals are passed to a speech recognizer for processing. The processed signals are examined to determine whether they indicate or otherwise suggest that the end user needs assistance. If assistance is needed, the system transmits to the end user sample prompts that demonstrate the proper response.

In a related aspect, the invention provides a speech-based assistance generator that includes a receiver and a speech recognition engine. Speech from an end user is received by the receiver and processed by the speech recognition engine, or alternatively, DTMF input from the end user is received. VoiceXML application logic determines whether speech-based assistance is needed and, if so, the VoiceXML interpreter executes logic to access an example user response phrase, or a grammar, or both, to produce one or more sample prompts. A transmitter sends a sample prompt to the end user to provide guidance.

In some embodiments, the methods of creating a software application, creating a natural language grammar, and performing speech recognition can be implemented in software. This software may be made available to developers and end users online and through download vehicles. It may also be embodied in an article of manufacture that includes a program storage medium such as a computer disk or diskette, a CD, DVD, or computer memory device.

Other aspects, embodiments, and advantages of the present invention will become apparent from the following detailed description which, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a flowchart that depicts the steps of building a software application in accordance with an embodiment of the invention;

FIG. 2 is an example screen display of a graphical user interface in accordance with an embodiment of the invention;

FIG. 3 is an example screen display of a device pane in accordance with an embodiment of the invention;

FIG. 4 is an example screen display of a device profile dialog box in accordance with an embodiment of the invention;

FIG. 5 is an example screen display of a base program element palette in accordance with an embodiment of the invention;

FIG. 6 is an example screen display of a programmatic program element palette in accordance with an embodiment of the invention;

FIG. 7 is an example screen display of a user input program element palette in accordance with an embodiment of the invention;

FIG. 8 is an example screen display of an application output program element palette in accordance with an embodiment of the invention;

FIG. 9 is an example screen display of an application outline view in accordance with an embodiment of the invention;

FIG. 10 is a block diagram of an example file structure in accordance with an embodiment of the invention;

FIG. 11 is an example screen display of an example voice conversation template in accordance with an embodiment of the invention;

FIG. 12 is a flowchart that depicts the steps to create a natural language grammar and help features in accordance with an embodiment of the invention;

FIG. 13 is a flowchart that depicts the steps to provide speech-based assistance in accordance with an embodiment of the invention;

FIG. 14 is a block diagram that depicts a visual programming apparatus in accordance with an embodiment of the invention;

FIG. 15 is a block diagram that depicts a natural language grammar generator in accordance with an embodiment of the invention;

FIG. 16 is a block diagram that depicts a speech-based assistance generator in accordance with an embodiment of the invention;

FIG. 17 is an example screen display of a grammar template in accordance with an embodiment of the invention

FIG. 18 is a block diagram that depicts overall operation of an application in accordance with an embodiment of the invention; and

FIG. 19 is an example screen display of a voice application simulator in accordance with an embodiment of the invention.

### DESCRIPTION

As shown in the drawings for the purposes of illustration, the invention may be embodied in a visual programming system. A system according to the invention provides the capability to develop software applications for multiple devices in a simultaneous fashion. The programming system also allows software developers to incorporate speech recognition features in their applications with relative ease. Developers can add such features without the specialized knowledge typically required when creating speech-enabled applications.

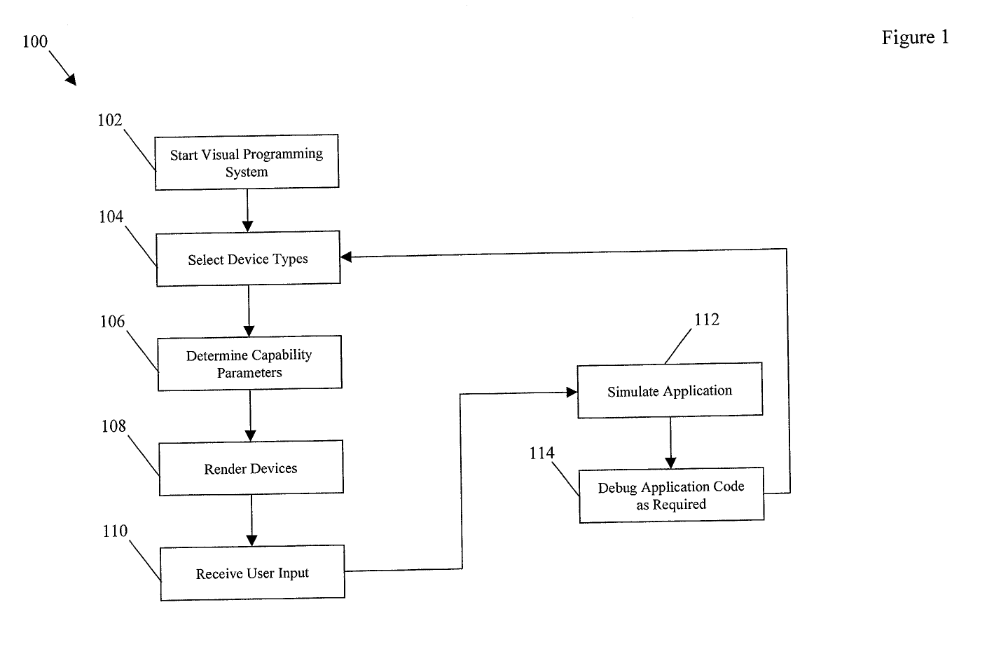

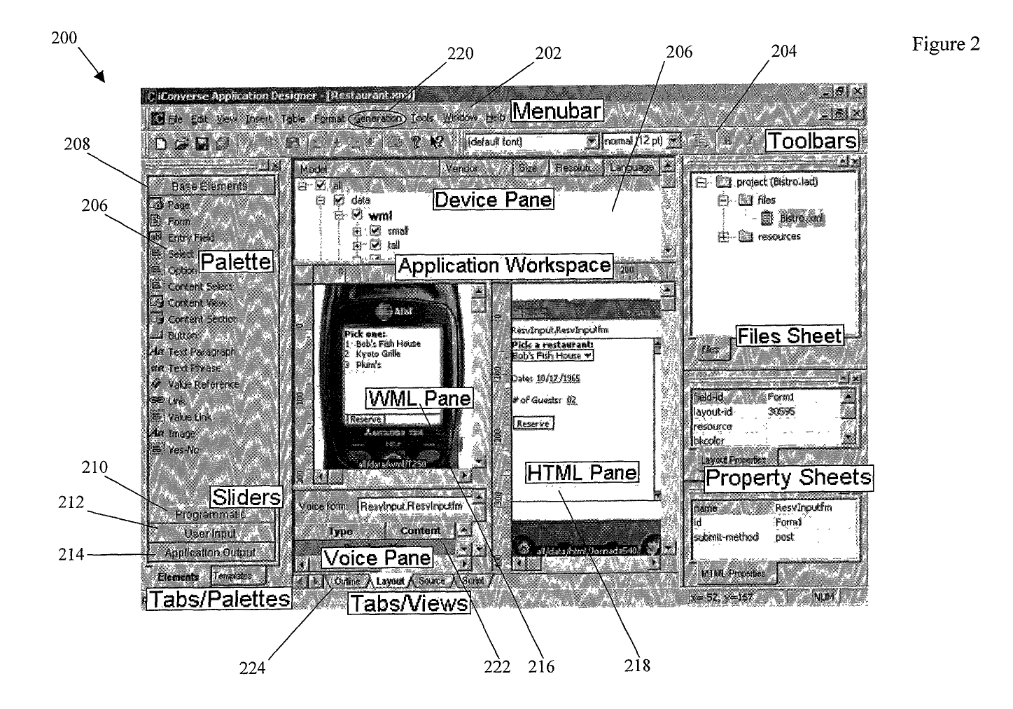

In brief overview, FIG. 1 shows a flowchart depicting a process 100 by which a software developer uses a system according to the invention to create a software application. As a first step, the developer starts the visual programming system (step 102). The system presents a user interface 200 as shown in FIG. 2. The user interface 200 includes a menu bar 202 and a toolbar 204. The user interface 200 is typically divided in to several sections, or panes, related to their functionality. These will be discussed in greater detail in the succeeding paragraphs.

Returning to FIG. 1, the developer then selects the device or devices that are to interact with the application (step 104) (the target devices). Example devices include those capable of displaying HyperText Markup Language (hereinafter, “HTML”), such as PDAs. Other example devices include wireless devices capable of displaying Wireless Markup Language (hereinafter, “WML”). Wireless telephones equipped with a browser are typically in this category. (As discussed below, devices such as conventional and wireless telephones that are not equipped with a browser, and are capable of presenting only audio, are served using the VoiceXML markup language. The VoiceXML markup language is interpreted by a VoiceXML browser that is part of a voice runtime service.)

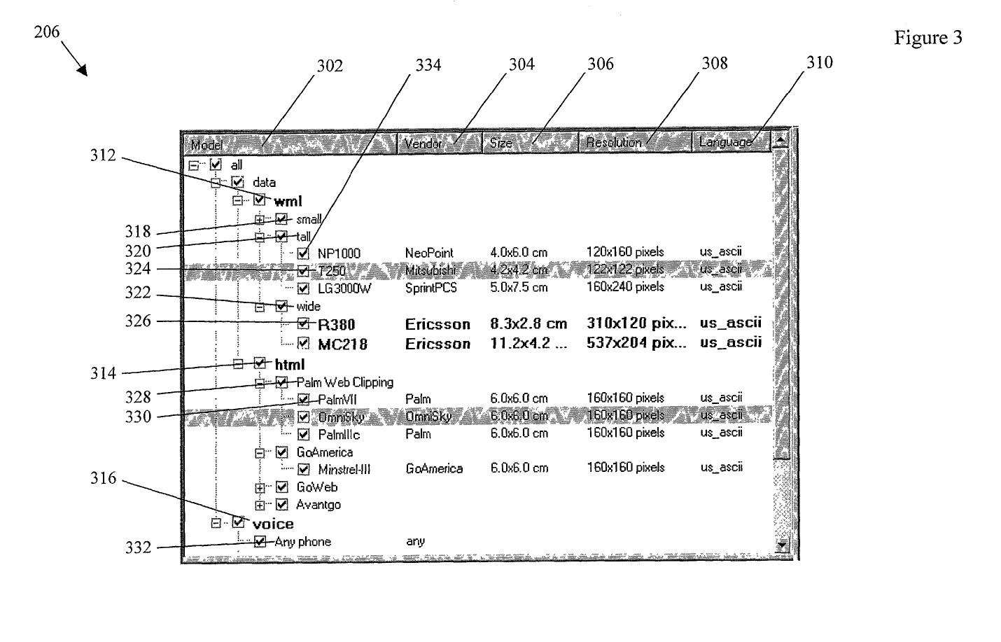

As shown in FIG. 2, an embodiment of the invention provides a device pane 206 within the user interface 200. The device pane 206, shown in greater detail in FIG. 3, provides a convenient listing of devices from which the developer may choose. The device pane 206 includes, for example, device-specific information such as model identification 302, vendor identification 304, display size 306, display resolution 308, and language 310. (In addition, the device-specific information may be viewed by actuating a pointing device, such as by “clicking” a mouse, over or near the model identification 302 and selecting “properties” from a context-specific menu.) In one embodiment of the invention, the devices are placed in three, broad categories: WML devices 312, HTML devices 314, and VoiceXML devices 316. Devices in each of these categories may be further categorized, for example, in relation to display geometry.

Referring to FIG. 3, the WML devices 312 are, in one embodiment, subdivided in to small devices 318, tall devices 320, and wide devices 322 based on the size and orientation of their respective displays. For example, a WML T250 device 324 represents a tall WML device 320. A WML R380 device 326 features a display that is representative of a wide WML device 322. In addition, the HTML devices 314 may also be further categorized. As shown in the embodiment depicted in FIG. 3, one category relates to Palm™-type devices 328. One example of such a device is an Palm VII™ device 330.

In one embodiment, each device and category listed in the device pane 206 includes a check box 334 that the developer may select or clear. By selecting the check box 334, the developer commands the visual programming system of the invention to generate code to allow the specific device or category of devices to interact with the application under development. Conversely, by clearing the check box 334, the developer can eliminate the corresponding device or category. The visual programming system will then refrain from generating the code necessary for the deselected device to interact with the application under development.

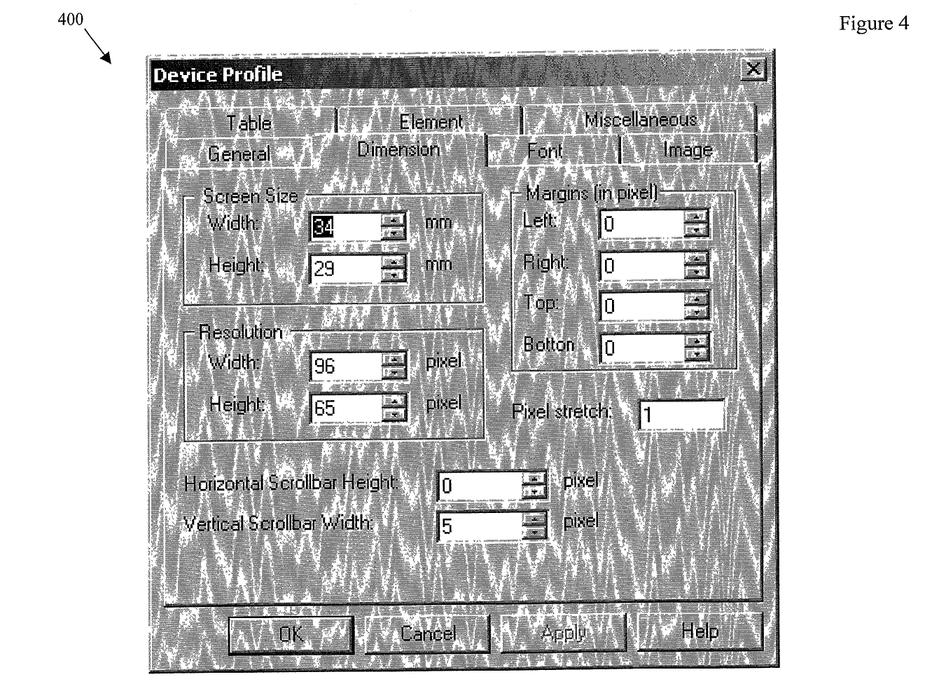

A system according to the invention includes information on the various capability parameters associated with each device listed in the device pane 206. These capability parameters include, for example, the aforementioned device-specific information. These parameters are included in a device profile. As shown in FIG. 4, a system according to the invention allows the developer to adjust these parameters for each category or device independently using an intuitive multi-tabbed dialog box 400. After the developer has selected the target devices, the system then determines which capability parameters apply (step 106).

In one embodiment, the visual programming system then renders a representation of at least one of the target devices on the graphical user interface (step 108). As shown in FIG. 2, a representation of a selected WML device appears in a WML pane 216. Similarly, a representation of a selected HTML device appears in an HTML pane 218. Each pane reproduces a dynamic image of the selected device. Each image is dynamic because it changes as a result of a real time simulation performed by the system in response to the developer's inputs in to, and interaction with, the system as the developer builds a software application with the system.

Once the representations of the target devices are displayed in the user interface 200, the system is prepared to receive input from the developer to create the software application (step 110). This input can encompass, for example, application code entered at a computer keyboard. It can also include “drag and drop” graphical operations that associate program elements with the application, as discussed below.

In one embodiment, the system, as it receives the input from the developer, simulates a portion of the software application on each target device (step 112). The results of this simulation are displayed on the graphical user interface 200 in the appropriate device pane. The simulation is typically limited to the visual aspects of the software application, is in response to the input, and is performed in substantially real time. In an alternative embodiment, the simulation includes operational emulation that executes at least part of the application. Operational emulation also includes voice simulation as discussed below. In any case, the simulation reflects the application the developer is creating during its creation. This allows the developer to debug the application code (step 114) in an efficient manner. For example, if the developer changes the software application to create a different display on a target device, the system updates each representation, in real time, to reflect that change. Consequently, the developer can see effects of the changes on several devices at once and note any unacceptable results. This allows the developer to adjust the application to optimize its performance, or appearance, or both, on a plurality of target devices, each of which may be a different device. As the developer creates the application, he or she can also change the selection of the device or devices that are to interact with the application (step 104).

A software application can typically be described as including one or more “pages.” These pages, similar to a web page, divide the application in to several logical or other distinct segments, thereby contributing to structural efficiency and, from the perspective of an end user, ease of operation. A system according to the invention allows the definition of one or more of these pages within the software application. Furthermore, in one embodiment, each of these pages can include a setup section, a completion section and a form section. The setup section is typically used to contain code that executes on a server when a page is requested by the end user, who is operating a client (e.g., a target device). This code can be used, for example, to connect to content sources for retrieving or updating data, to define programming scope, and to define links to other pages.

When a page is displayed, the end user typically enters information and then submits this information to the server. The completion section is generally used to contain code, such as that to assign and bind, which is executed on the submittal. There can be several completion sections within a given page, each having effect, for example, under different submittal conditions. Lastly, the form section is typically used to contain information related to a screen image that is designed to appear on the client. Because many client devices have limited display areas, it is sometimes necessary to divide the appearance of a page in to several discrete screen images. The form section facilitates this by reserving an area within the page for the definition of each screen display. There can be multiple form sections within a page to accommodate the need for multiple or sequential screen displays in cases where, for example, the page contains more data that can reasonably be displayed simultaneously on the client.

In one embodiment, the system provides several program elements that the developer uses to construct the software application. These program elements are displayed on a palette 206 of the user interface 200. The developer places one or more program elements in the form section of the page. The program elements are further divided in to several categories, including: base elements 208, programmatic elements 210, user input elements 212, and application output elements 214.

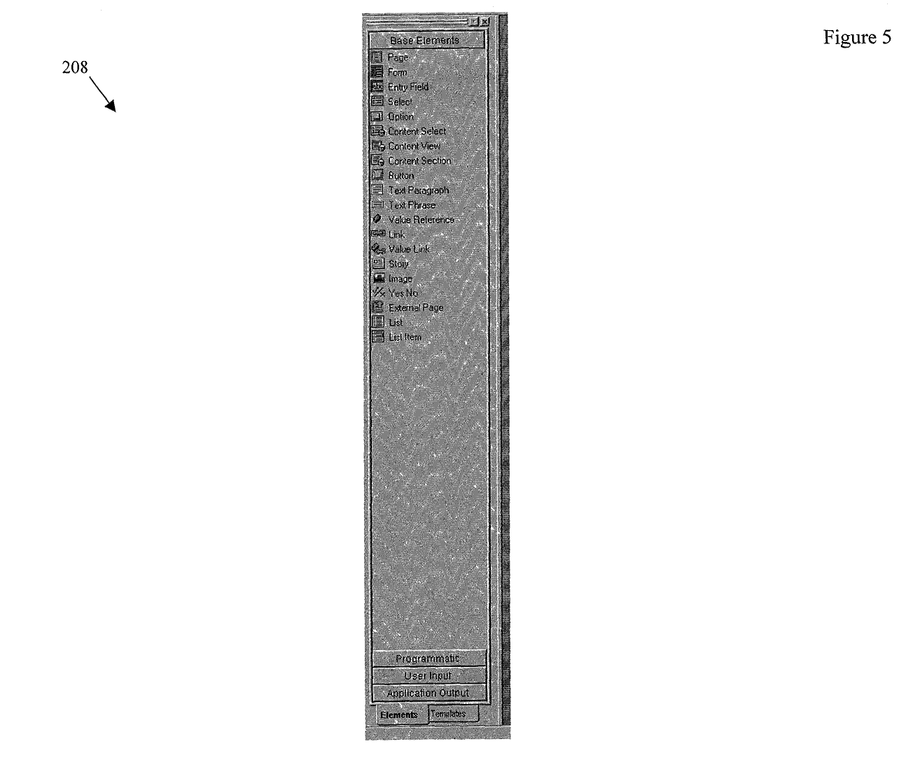

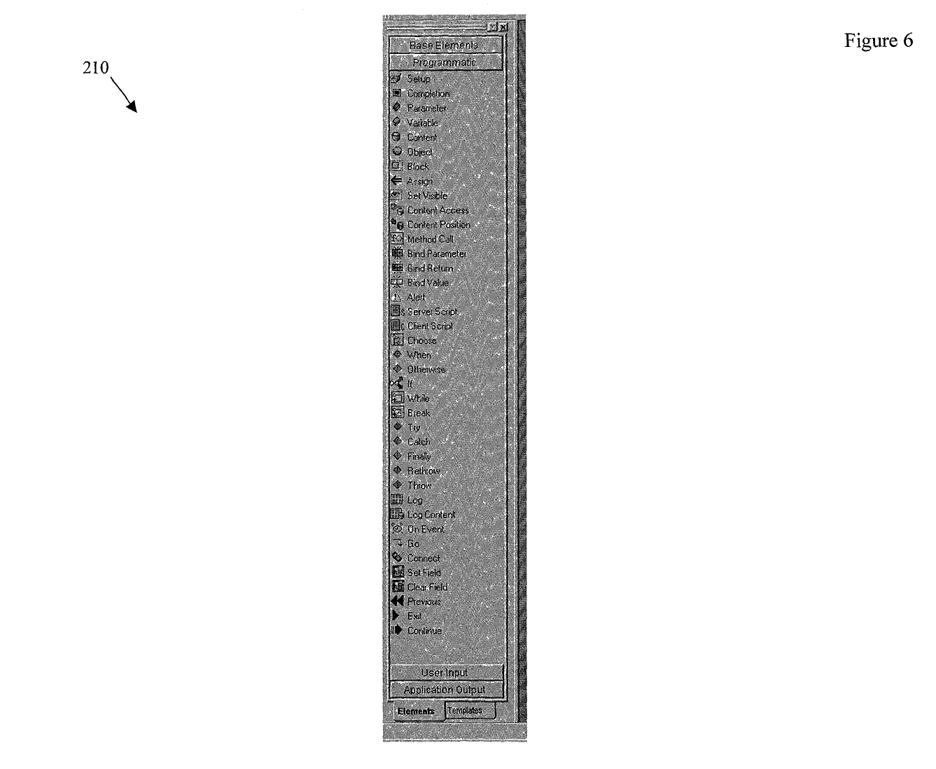

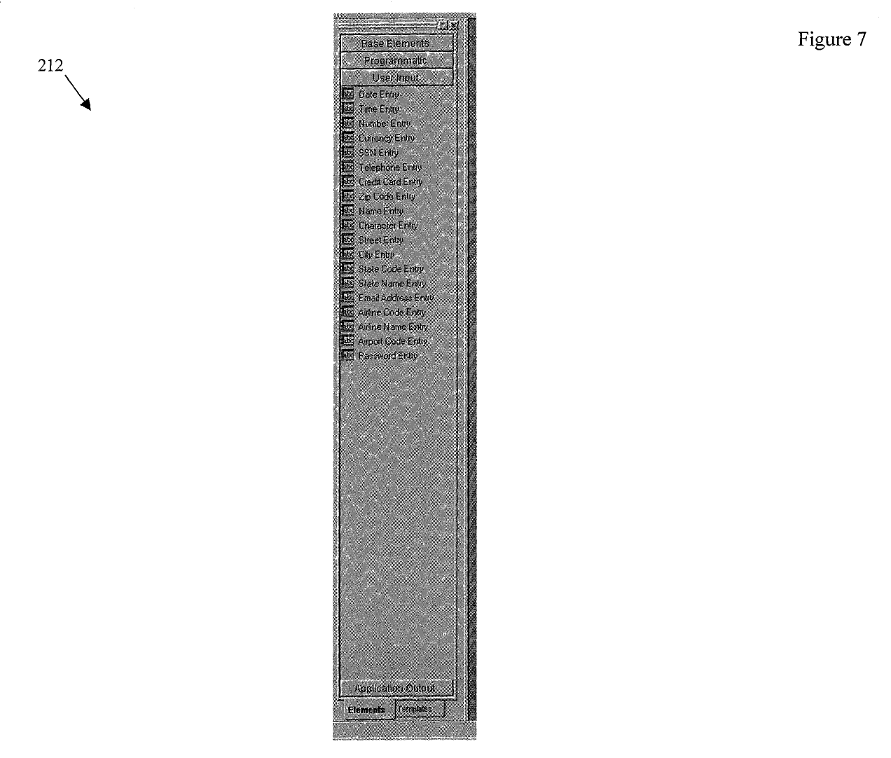

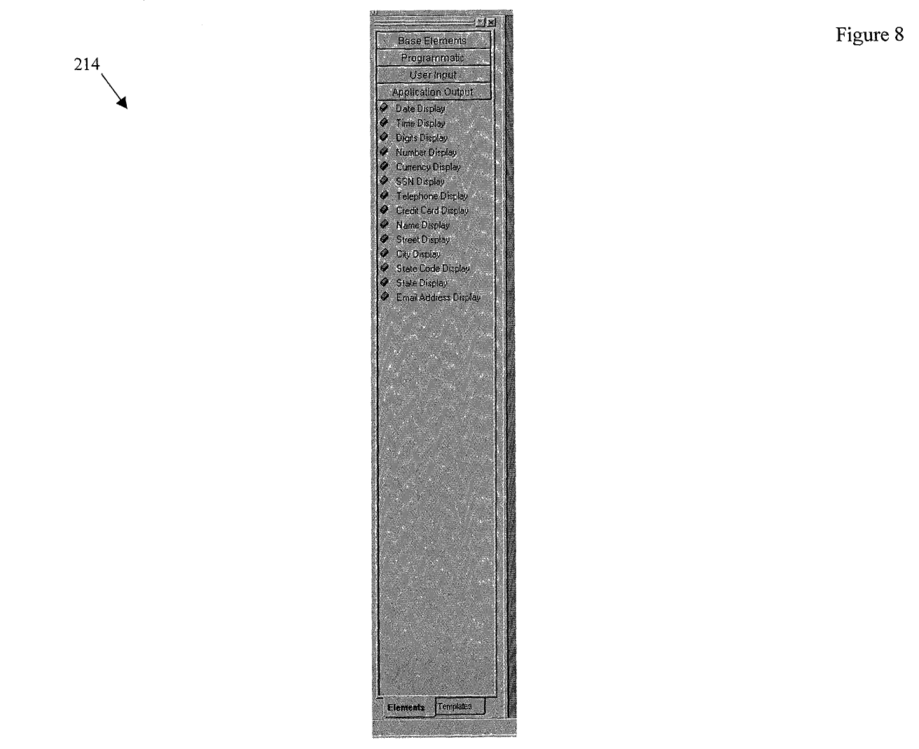

As shown in the example depicted in FIG. 5, the base elements 208 include several primitive elements provided by the system. These include elements that define a form, an entry field, a select option list, and an image. FIG. 6 depicts an example of the programmatic elements 210. The developer uses the programmatic elements 210 to create the logic of the application. The programmatic elements 210 include, for example, a variable element and conditional elements such as “if” and “while”. FIG. 7 is an example showing the user input elements 212. Typical user input elements 212 include date entry and time entry elements. An example of the application output elements 214 is given in FIG. 8 and includes name and city displays.

To include a program element in the software application, the developer selects one or more elements from the palette 206 using, for example, a pointing device, such as a mouse. The developer then performs a “drag and drop” operation: dragging the selected element to the form and dropping it in a desired location within the application. This operation associates a program element with the page. The location can be a position in the WML pane 216 or the HTML pane 218.

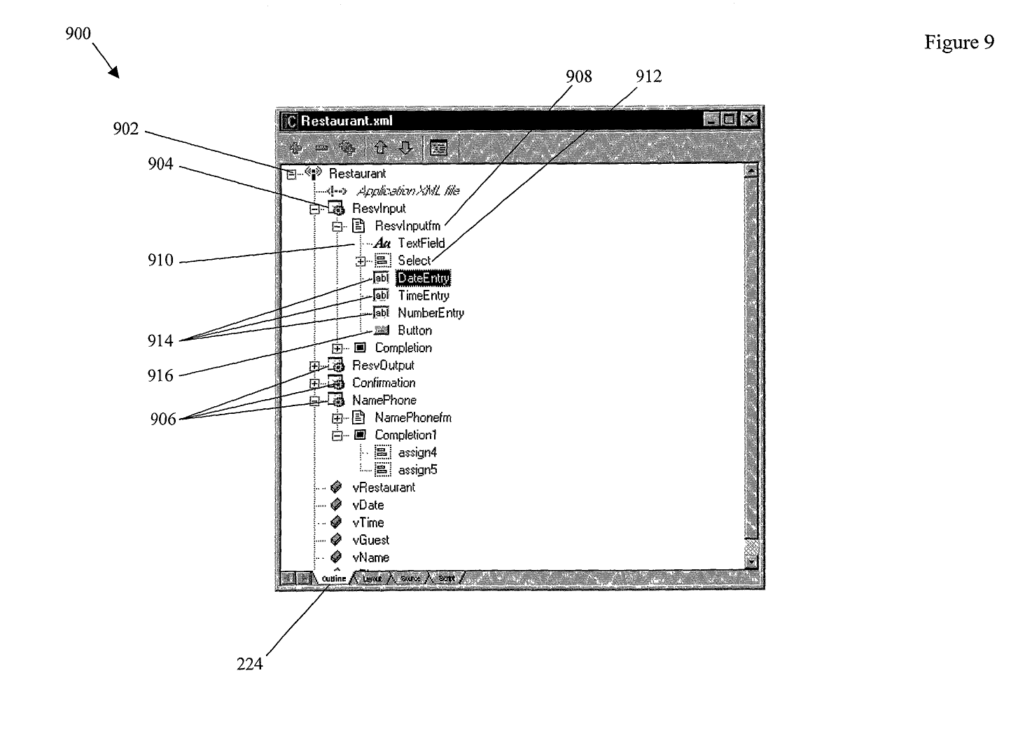

As an alternative, a developer can display the software application in an outline view 900 as shown in FIG. 9. The outline view 900 is accessible from the user interface 200 by selecting outline tab 224. The outline view 900 renders the application in a tree-like structure that delineates each page, form, section, and program element therein. As an illustrative example, FIG. 9 depicts a restaurant application 902. Within the restaurant application 902 is an application page 904, and further application pages 906. The application page 904 includes a form 908. Included within the form 908 are program elements 910, 912, 914, 916.

Using a similar drag and drop operation, the developer can drag the selected element into a particular position on the outline view 900. This associates the program element with the page, form, or section related to that position.

Although the developer can drop a program element on only one of the WML pane 216, the HTML pane 218, or the outline view 900, the effect of this action is duplicated on the remaining two. For example, if the developer drops a program element in a particular position on the WML pane 216, a system according to the invention also places the same element in the proper position in the HTML pane 218 and the outline view 900. As an option, the developer can turn off this feature for a specific pane by deselecting the check box 334 associated with the corresponding target device or category.

The drag and drop operation associates the program element with a page of the application. The representations of target devices in the WML pane 216 and the HTML pane 218 are updated in real time to reflect this association. Thus, the developer sees the visual effects of the association as the association is created.

Each program element includes corresponding markup code in Multi-Target Markup Language™ (hereinafter, “MTML”). MTML™ is a language based on Extensible Markup Language (hereinafter, “XML”), and is copyright protected by iConverse, Inc., of Waltham, Mass. MTML is a device-independent markup language. It allows a developer to create software applications with specific user interface attributes for many client devices without the need to master the various display capabilities of each device.

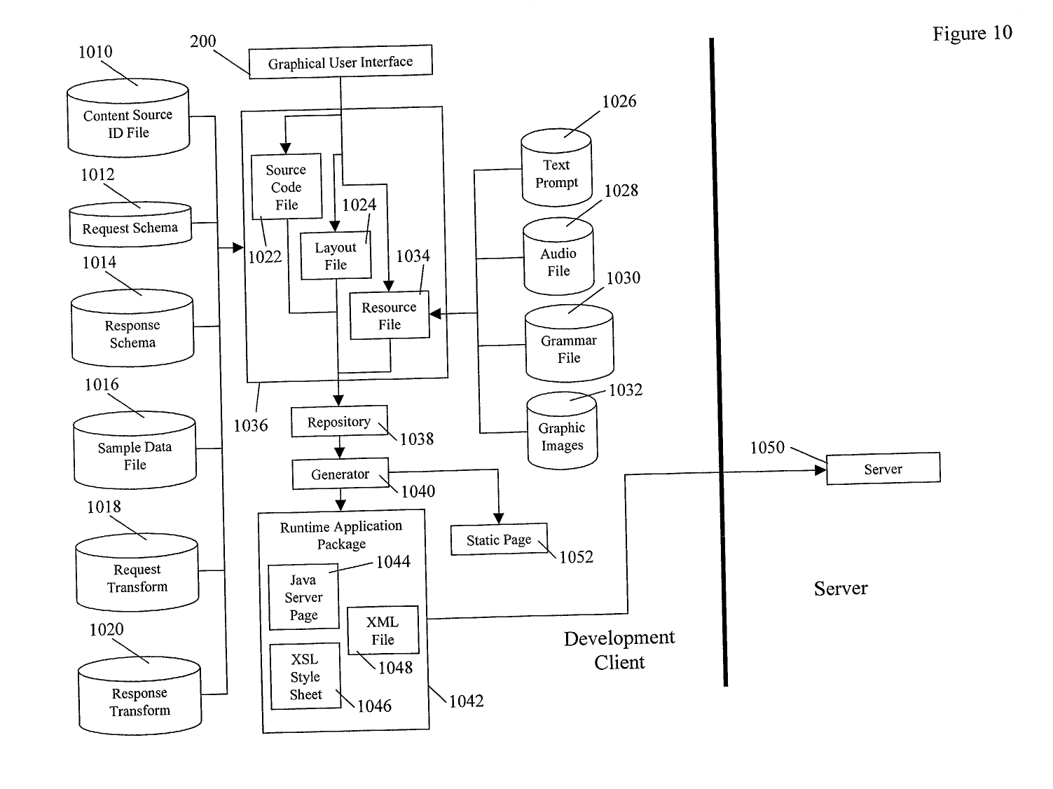

Referring to FIG. 10, the MTML that corresponds to each program element the developer has selected is stored, typically in a source code file 1022. In response to the capability parameters, the system adapts the MTML to each target device the developer selected in step 104 in a substantially simultaneous fashion. In one embodiment, the adaptation is accomplished by using a layout file 1024. The layout file 1024 is XML-based and stores information related to the capabilities of all possible target devices and device categories. During adaptation, the system establishes links between the source code file 1022 and those portions of the layout file 1024 that include the information relating to the devices selected by the developer in step 104. The establishment of these links ensures the application will appear properly on each target device.

In one embodiment, content that is ancillary to the software application may be defined and associated with the program elements available to the developer. This affords the developer the opportunity to create software applications that feature dynamic attributes. To take advantage of this capability, the ancillary content is typically defined by generating a content source identification file 1010, request schema 1012, response schema 1014, and a sample data file 1016. In a different embodiment, the ancillary content is further defined by generating a request transform 1018 and a response transform 1020.

The source identification file 1010 is XML-based and generally contains the URL of the content source. The request schema 1012 and response schema 1014 contain the formal description (in XSD format) of the information that will be submitted when making content requests and responses. The sample data file 1016 contains a small of amount of sample content captured from the content source to allow the developer to work when disconnected from a network (thereby being unable to access the content source). The request transform 1018 and the response transform 1020 specify rules (in XSL format) to reshape the request and response content.

In one embodiment, the developer can also include Java-based code, such as JavaScript or Java, associated with an MTML tag and, correspondingly, the server will execute that code. Such code can reference data acquired or to be sent to content sources through an Object Model. (The Object Model is a programmatic interface callable through Java or JavaScript that accesses information associated with an exchange between an end user and a server.)

Each program element may be associated with one or more resources. In contrast to content, resources are typically static items. Examples of resources include a text prompt 1026, an audio file 1028, a grammar file 1030, and one or more graphic images 1032. Resources are identified in an XML-based resource file 1034. Each resource may be tailored to a specific device or category of devices. This is typically accomplished by selecting the specific device or category of devices in device pane 206 using the check box 334. The resource is displayed in the user interface 200, where the developer can optimize the appearance of the resource for the selected device or category of devices. Consequently, the developer can create different or alternative versions of each resource with characteristics tailored for devices of interest.

The source code file 1022, the layout file 1024, and the resource file 1034 are typically classified as an application definition file 1036. In one embodiment, the application definition file 1036 is transferred to a repository 1038, typically using a standard protocol, such as “WebDAV” (World Wide Web Distributed Authoring and Versioning; an initiative of the Internet Engineering Task Force; refer to the link http://www.ics.uci.edu/pub/ietf/webdav for more information).

In one embodiment, the developer uses a generate button 220 on the menu bar 202 to generate a runtime application package 1042 from the application definition file 1036 in the repository 1038. A generator 1040 performs this operation. The runtime application package 1042 includes at least one Java server page 1044, at least one XSL style sheet 1046 (e.g., one for each target device or category of target devices, when either represent unique layout information), and at least one XML file 1048. The runtime package 1042 is typically transferred to an application server 1050 as part of the deployment of the application. In a further embodiment, the generator 1040 creates one or more static pages in a predetermined format (1052). One example format is the PQA format used by Palm devices. More details on the PQA format are available from Palm, Inc., at the link http://www.palm.com/devzone/webclipping/pqa-talk/pqa-talk.html#technical.

The Java server page 1044 typically includes software code that is invoked at application runtime. This code identifies the client device in use and invokes at least a portion of the XSL style sheet 1046 that is appropriate to that client device. (As an alternative, the code can select a particular XSL style sheet 1046 out of several generated and invoke it in its entirety.) The code then generates a client-side markup code appropriate to that client device and transmits it to the client device. Depending on the type and capabilities of the client device, the client-side markup code can include WML code, HTML code, and VoiceXML code.

VoiceXML is a language based on XML and is intended to standardize speech-based access to, and interaction with, web pages. Speech-based access and interaction generally include a speech recognition system to interpret commands or other information spoken by an end user. Also typically included is a text-to-speech system that can be used, for example, to aurally describe the contents of a web page to an end user. Adding these speech features to a software application facilitates the widespread use of the application on client devices that lack the traditional user interfaces, such as keyboards and displays, for end user input and output. The presence of the speech features allows an end user to simply listen to a description of the content that would typically be displayed, and respond by voice instead. Consequently, the application may be used with, for example, any telephone. The end user's speech or other sounds, such as DTMF tones, or a combination thereof, are used to control the application.

As described above in relation to FIG. 3, the developer can select target devices that include WML devices 312 and HTML devices 314. In addition, a system according to the invention allows the developer to select VoiceXML devices 316 as a target device as well. A phone 332 (i.e., telephone) is an example of the VoiceXML device 316. In one embodiment, when the developer includes a program element in the application, and the VoiceXML device 316 is selected as a target device, a voice conversation template is generated in response to the program element. The voice conversation template represents a conversation between an end user and the application. It is structured to provide or receive information associated with the program element.

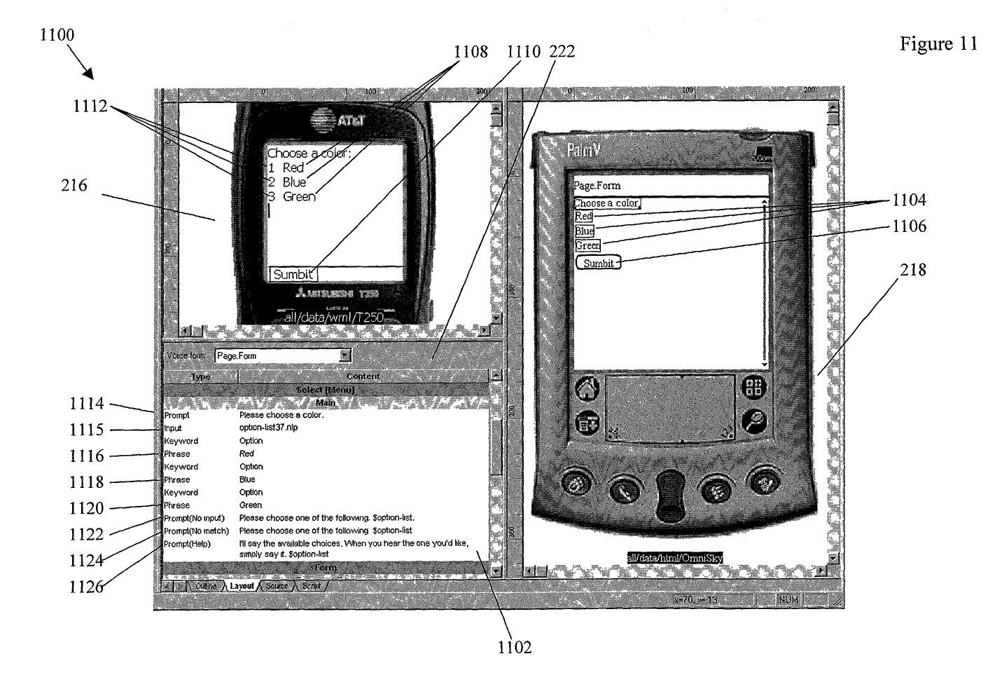

FIG. 11 depicts a portion 1100 of the user interface 200 that includes the WML pane 216, the HTML pane 218, and a voice pane 222. This portion of the user interface allows the developer to view and edit the presentation of the application as it would be realized for the displayed devices. The voice pane 222 displays a conversation template 1102 that represents the program element present in the WML pane 216 and the HTML pane 218. The program element used in the example given in FIG. 11 is the “select” element. The select element presents an end user with a series of choices (three choices in FIG. 11), one of which the end user chooses. In the HTML pane 218, the select element appears as an HTML list of the items 1104. When using an HTML client, the end user would click on or otherwise denote the desired item, and then actuate a submit button 1106. In the WML pane 216, a WML list of items 1108 appears. The WML list of items 1108 is similar to the HTML list of the items 1104, except that the former includes list element numbers 1112. When using a WML client, the end user would select an item from the list by entering the corresponding list element number 1112, and then actuate a submit button 1110.

The conversation template 1102 provides a spoken equivalent to the select program element. A system according to the invention provides an initial prompt 1114 that the end user will hear at this point in the application. The initial prompt 1114, like other items in the conversation template 1102, has a default value that the developer can modify. In the example shown in FIG. 11, the initial prompt 1114 was changed to “Please choose a color”. This is what the end user will hear. Similarly, each item the end user can select has associated phrases 1116, 1118, 1120, which may be played to the user after the initial prompt 1114. The user can interrupt this playback. An input field 1115 specifies the URL of the corresponding grammar and other language resources needed for speech recognition of the end user's choices. The default template specifies prompts and actions to take on several different conditions; these may be modified by the application developer if so desired. Representative default prompts and actions are illustrated in FIG. 11: If the end user fails to respond, a no input prompt 1122 is played. If the end user's response is not recognized as one of the items that can be selected, a no match prompt 1124 is played. A help prompt 1126 is also available that can be played, for example, on the end user's request or on explicit VoiceXML application program logic conditions.

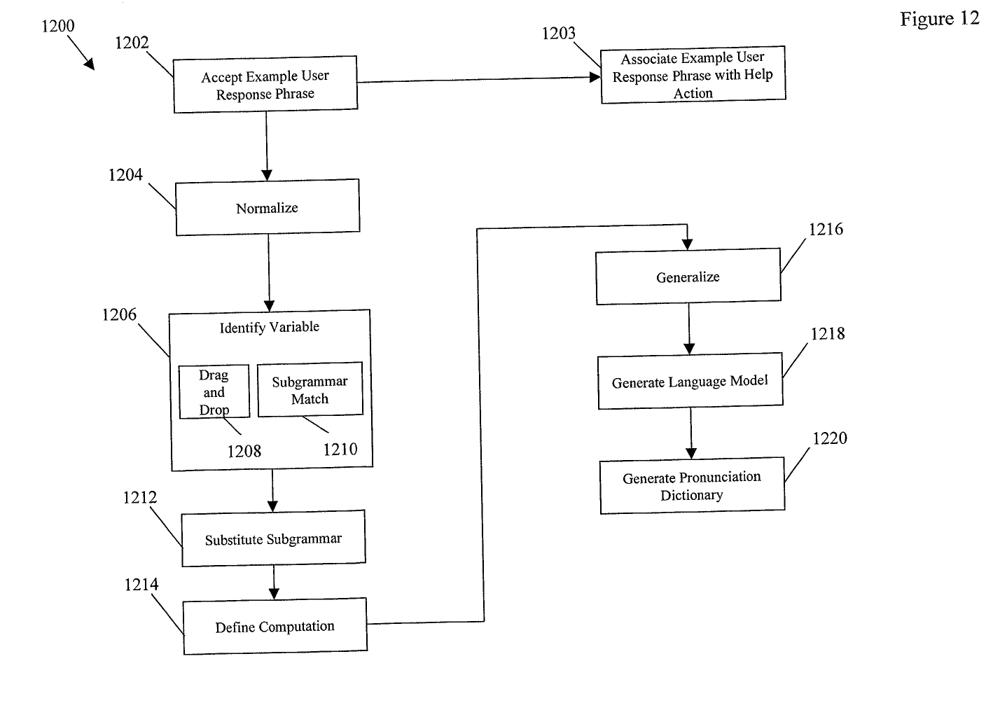

Using the input field 1115, a program element may reference different types of resources. These include pre-built language resources (typically provided by others). These pre-built language resources are usually associated with particular layout elements, and the developer selects one implicitly when choosing the particular voice layout element. A program element may also reference language resources that will be built automatically by the generation process at application design time, at some intermediate time, or during runtime. (Language resources built at runtime include items such as, for example, dynamic data and dynamic grammars.) Lastly, a program element may reference language resources such as a natural language grammar created, for example, by the method depicted in FIG. 12 and discussed in further detail below.

As additional program elements are added to the application, additional voice conversation templates are added to the voice pane 222. Each template has default language resource references, structure, conversation flow, and dialog that are appropriate to the corresponding program element. This ensures that speech-based interaction with the elements provides the same or similar capabilities as those present in the WML or HTML versions of the elements. In this way, one interacting with the application using a voice client can experience a substantially lifelike form of artificial conversation, and does not experience an unacceptably diminished user experience in comparison with one using a WML or HTML client.

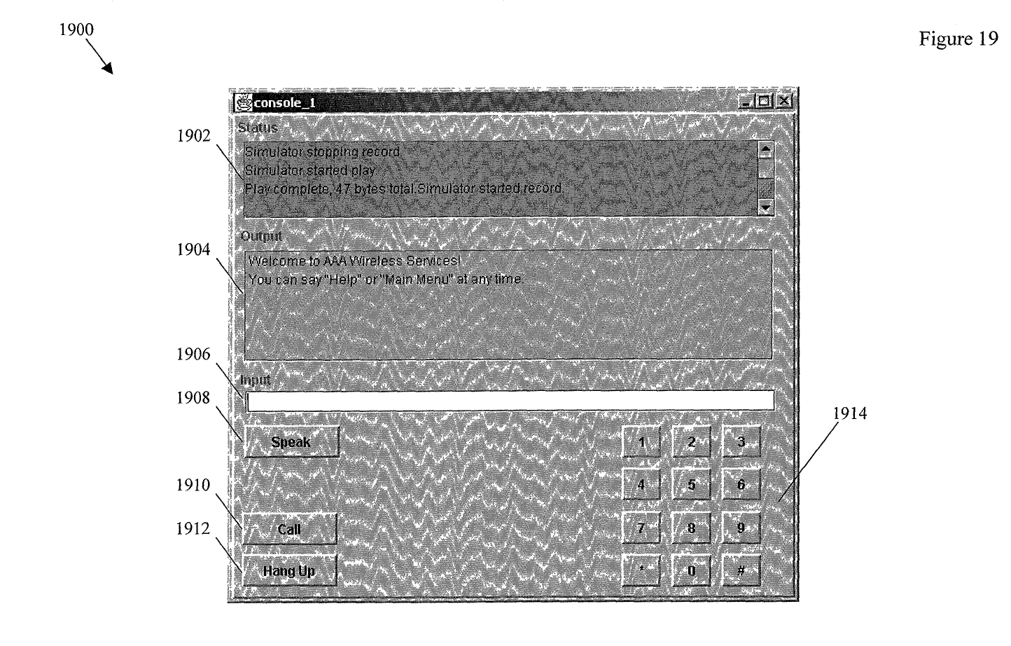

To augment the conversation template 1102, a system according to the invention provides a voice simulator 1900 as shown in FIG. 19. The voice simulator 1900 allows the developer to simulate voice interactions the end user would have with the application. The voice simulator 1900 includes information on application status 1902 and a text display of application output 1904. The voice simulator 1900 also includes a call initiation function button 1910, a call hang-up function button 1912, and DTMF buttons 1914. Typically, the developer enters text in an input box 1906 and actuates a speak function button 1908, or the equivalent (such as, for example, the “enter” key on a keyboard). This text corresponds to what an end user would say in response to a prompt or query from the application at runtime.

For an application to include a speech recognition capability, a developer creates a grammar that represents the verbal commands or phrases the application can recognize when spoken by an end user. A function of the grammar is to characterize loosely the range of inputs from which information can be extracted, and to systematically associate inputs with the information extracted. Another function of the grammar is to constrain the search to those sequences of words that likely are permissible at some point in an application to improve the speech recognition rate and accuracy. Typically, a grammar comprises a simple finite state structure that corresponds to a relatively small number of permissible word sequences.

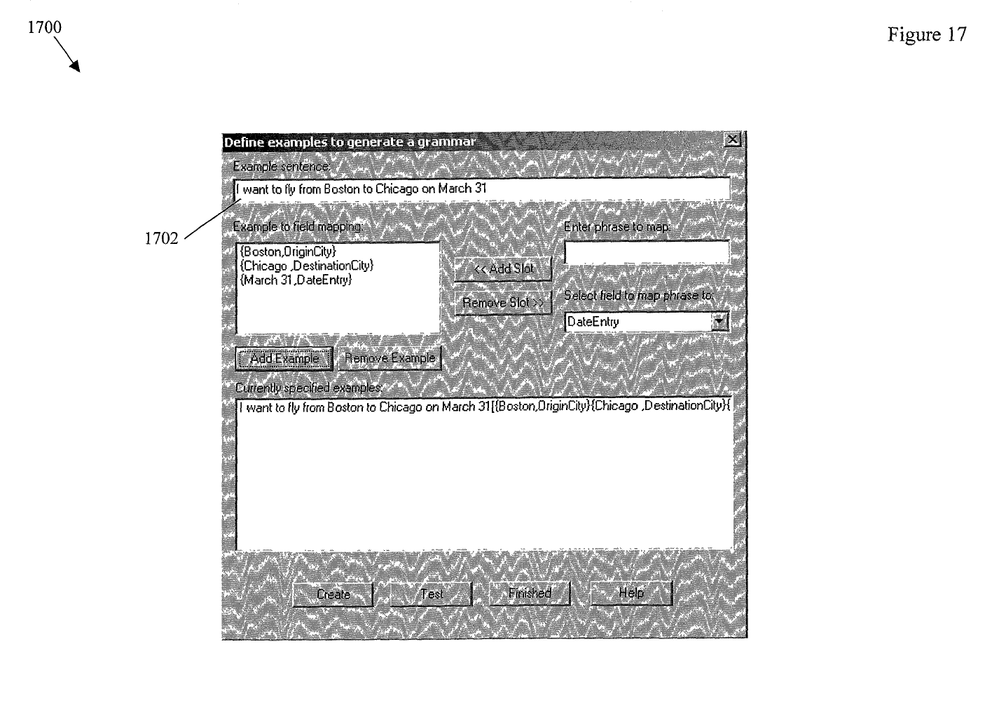

Typically, creating a grammar can be a tedious and laborious process, requiring specialized knowledge about speech recognition theory and technology. Nevertheless, FIG. 12 shows an embodiment of the invention that features a method of creating a natural language grammar 1200 that is simple and intuitive. A developer can master the method 1200 with little or no specialized training in the science of speech recognition. Initially, this method includes accepting one or more example user response phrases (step 1202). These phrases are those that an end user of the application would typically utter in response to a specific query. For example, in the illustration above where an end user is to select a color, example user response phrases could be “I'd like the blue one” or “give me the red item”. In either case, the system accepts one or more of these phrases from the developer. In one embodiment, a system according to the invention features a grammar template 1700 as shown in FIG. 17. Using a keyboard, the developer simply types these phrases into an example phrase text block 1702. Other methods of accepting the example user response phrases are possible, and may include entry by voice.

In one embodiment, an example user response phrase is associated with a help action (step 1203). This is accomplished by the system inserting text from the example user response phrase into the help prompt 1126. The corresponding VoiceXML code is generated and included in the runtime application package 1042. This allows the example user response phrase to be used as an assistance prompt at runtime, as discussed below. In addition to the example phrases provided by the developer, the resultant grammar (see below) may be used to derive example phrases targeted to specific situations. For instance, a grammar that includes references to several different variables may be used to generate additional example phrases referencing subsets of the variables. These example phrases are inserted into the help portion of the conversation template 1102. As code associated with the conversation template 1102 is generated, code is also generated which, at runtime, (1) identifies the variables that remain to be filled, and (2) selects the appropriate example phrases for filling those variables. Representative example phrases include the following:

“Number of guests is six.”

[symbol]

#guests variable

“Six guests at seven PM.”

[symbol]

#guests AND time variables

“Time is seven PM on Friday.”

[symbol]

time AND date variables

In this way, the example phrases can include multi-variable utterances.

In one embodiment, the example user response phrases are normalized using the process of tokenization (step 1204). This process includes standardizing orthography such as spelling, capitalization, acronyms, date formats, and numerals. Normalization occurs following the entry of the example user phrase. Thus, the other steps, particularly generalization (step 1216), are performed on normalized data.

Each example user response phrase typically includes text that is associated with one or more variables that represent data to be passed to the application. (As used herein in conjunction with the example user response phrase, the term “variable” encompasses the text in the example user response phrase that is associated with the variable.) These variables correspond to form fields specified in the voice pane 222. (As shown in FIG. 11, the form fields include the associated phrases 1116, 1118, 1120.) Referring to the earlier example, the example user response phrases could be rewritten as “I'd like the <color> one” or “give me the <color> item”, where <color> is a variable. Each variable can have a value, such as “blue” or “red” in this example. In general, the value can be the text itself, or other data associated with the text. Typically, a subgrammar, as discussed below, specifies the association by, for example, direct equivalence or computation. To create a grammar, each variable in the example user response phrases is identified (step 1206). In one embodiment, this is accomplished by the developer explicitly selecting that part of each example user response phrase that includes the variable and copying that part to the grammar template 1700. For example, the developer can, using a pointing device such as a mouse, highlight the appropriate part of each example user response phrase, and then drag and drop it into the grammar template (step 1208). The developer can also click on the highlighted part of the example user response phrase to obtain a context-specific menu that provides one or more options for variable identification.

Each variable in an example user response phrase also has a data type that describes the nature of the value. Example data types include “date”, “time”, and “corporation” that represent a calendar date value, a time value, and the name of a business or corporation selected from a list, respectively. In the case of the <color>example discussed above, the data type corresponds to a simple list. These data types may also be defined by a user-specified list of values either directly entered or retrieved from another content source. Data types for these purposes are simply grammars or specifications for gammars that detail requirements for grammars to be created at a later time. When the developer invokes the grammar generation system, the latter is provided with information on the variables (and their corresponding data types) that are included in each example user response phrase. Consequently, the developer need not explicitly specify each member of the set of possible variables and their corresponding data types, because the system performs this task.

Each data type also has a corresponding subgrammar. A subgrammar is a set of rules that, like a grammar, specify what verbal commands and phrases are to be recognized. A subgrammar is also used as the data type of a variable and its corresponding form field in the voice pane 222.

In an alternative embodiment, the developer implicitly associates variables with text in the example user response phrases by indicating which data are representative of the value of each variable (i.e., example or corresponding values). The system, using each subgrammar corresponding to the data types specified, then parses each example user response phrase to locate that part of each phrase capable of having the corresponding value (step 1210). Each part so located is associated with its variable.

Once a variable and its associated subgrammar are known, that part of each example user response phrase containing the variable is replaced with a reference to the associated subgrammar (step 1212). A computation to be performed by the subgrammar is then defined (step 1214). This computation provides the corresponding value for the variable during, for example, application runtime.

Generalization (step 1216) expands the grammar, thereby increasing the scope of words and phrases to be recognized, through several methods of varying degree that are at the discretion of the developer. For example, additional recognizable phrases are created when the order of the words in an example user response phrase is changed in a logical fashion. To illustrate, the developer of a restaurant reservation application may provide the example user response phrase “I would like a table for six people at eight o'clock.” The generalization process augments the grammar by also allowing recognition of the phrase “I would like a table at eight o'clock for six people.” The developer does not need to provide both phrases: a system according to the invention generates alternative phrases with little or no developer effort.

During the generalization process, having first obtained a set of user example response phrases, as well as the variables and values associated with each phrase, each phrase is parsed (i.e., analyzed) to obtain one or more linguistic descriptions. These linguistic descriptions are composed of characteristics which may, (i) span the entire response or be localized to a specific portion of it, (ii) be hierarchically structured in relationship to one another, (iii) be collections of what are referred to in linguistic theory as categories, slots, and fillers, (or their analogues), and (iv) be associated with the phonological, lexical, syntactic, semantic, or pragmatic level of the response.

The relationships between these characteristics may also imply constraints on one or more of them. For instance, a value might be constrained to be the same across multiple characteristics. Having identified these characteristics, as well as any constraints upon them, the linguistic descriptions are generalized. This generalization may include (1) eliminating one or more characteristics, (2) weakening or eliminating one or more constraints, (3) replacing characteristics with linguistically more abstract alternatives, such as parents in a linguistic hierarchy or super categories capable of unifying (under some linguistic definition of unification) with characteristics beyond the original one found in the description, and (4) replacing the value of a characteristic with a similarly more linguistically abstract version.

Having determined what set of characteristic and constraint generalizations is appropriate, a generalized linguistic description is stored in at least one location. This generalized linguistic description is used to analyze future user responses. To further expand on the example above, “I would like a table for six people at eight o'clock” with the <variable>/value pairs of <#guests>=6 and <time>=8:00, one possible linguistic description of this response is:

```
[s sem=request(table(<#guest>s=6,<time>=8:00,date=?))
  [np-pronoun lex=“I” person=1^{st} number=singular]
  [vp lex= “would like” sem=request mood=subjunctive number=singular
```

[np lex=“a table” number=singular definite=false person=3^{rd}

[pp lex=“for” sem=<#guest>s=6

[np definite=false

[adj-num lex=“six” number=plural]
[np lex= “people” number=plural person=3^{rd}]]]

[pp lex=“at” sem=<time>=8:00

[np lex=“eight o’clock” ]]]]]

From this description, some example generalizations might include:

(1) Permit any verb (predicate) with “request” semantics. This would allow “I want a table for six people at eight o'clock.”

(2) Permit any noun phrase as subject, constraining number agreement with the verb phrase. This would allow “We would like a table for six people at eight o'clock.”

(3) Constrain number agreement between the lexemes corresponding to “six” and “people”. This would allow “I would like a table for one person at eight o'clock.” It would exclude “I would like a table for one people at eight o'clock.”

(4) Allow arbitrary ordering of the prepositional phrases which attach to “a table”. This would allow “I would like a table at eight o'clock for six people.”

Having determined these generalizations, a representation of the linguistic description that encapsulates them is stored to analyze future user responses.

From the examples above, it will be appreciated that an advantage of this method of creating a grammar from developer-provided example phrases is the ability to fill multiple variables from a single end user utterance. This ability is independent of the order in which the end user presents the information, and independent of significant variations in wording or phrasing. The runtime parsing capabilities provided to support this include:

(1) an island-type parser, which exploits available linguistic information while allowing the intervention of words that do not contribute linguistic information,

(2) the ability to apply multiple grammars to a single utterance,

(3) the ability to determine what data type value is specified by a portion of the utterance, and

(4) the ability to have preferences, or heuristics, or both, to determine which variable/value pairs an utterance specifies.

Another example of generalization includes expanding the grammar by the replacement of words in the example user response phrases with synonyms. To illustrate, the developer of an application for the car rental business could provide the example user response phrase “I'd like to reserve a car.” The generalization process can expand the grammar by allowing the recognition of the phrases “I'd like to reserve a vehicle” and “I'd like to reserve an auto.” Generalization also allows the creation of multiple marker grammars, where the same word can introduce different variables, potentially having different data types. For example, a multiple marker grammar can allow the use of the word “for” to introduce either a time or a quantity. In effect, generalization increases the scope of the grammar without requiring the developer to provide a large number of example user response phrases.

In another embodiment, recognition capabilities are expanded when it is determined that the values corresponding to a variable are part of a restricted set. To illustrate, assume that in the color example above only “red”, “blue”, and “green” are acceptable responses to the phrase “I'd like the <color> one”. A system according to the invention then generates a subset of phrases associated with this restricted set. In this case, the phrases could include “I'd like red”, “I'd like blue”, “I'd like green”, or simply “red”, “blue”, or “green”. The subset typically includes single words from the example user response phrase. Some of these single words, such as “I'd” or “the” in the present example, are not sufficiently specific. Linguistic categories are used to identify such single words and remove them from the subset of phrases. The phrases that remain in the subset define a flat grammar. In an alternative embodiment, this flat grammar can be included in the subgrammar described above. In a further embodiment, the flat grammar, one or more corresponding language models and one or more pronunciation dictionaries are created at application runtime, typically when elements of the restricted set are known at runtime and not development time. Such a grammar, generated at runtime, is typically termed a “dynamic grammar.” Whether the flat grammar is generated at development time or runtime, its presence increases the number of end user responses that can be recognized without requiring significant additional effort on the part of the developer.

After a grammar is created, a language model is then generated (step 1218). The language model provides statistical data that describes the probability that certain sequences of words may be spoken by an end user. A language model that provides probability information on sequences of two words is known as a “bigram” model. Similarly, a language model that provides probability information on sequences of three words is termed a “trigram” model. In one embodiment, to generate a collection of word sequences to determine which the grammar can match, a parser operates on the grammar that has been created. Because these sequences can have a varying number of words, the resulting language model is called an “n-gram” model. This n-gram model is used in conjunction with an n-gram language model of general English to recognize not only the word sequences specified by the grammar, but also other unspecified word sequences. This, when combined with a grammar created according to an embodiment of the invention, increases the number of utterances that get interpreted correctly and allows the end user to have a more natural dialog with the system. If a grammar refers to other subgrammars, the language model refers to the corresponding sub-language models.

The pronunciation of the words and phrases in the example user response phrases, and those that result from the grammar and language model created as described above, must be determined. This is typically accomplished by creating a pronunciation dictionary (step 1220). The pronunciation dictionary is a list of word-pronunciation pairs.

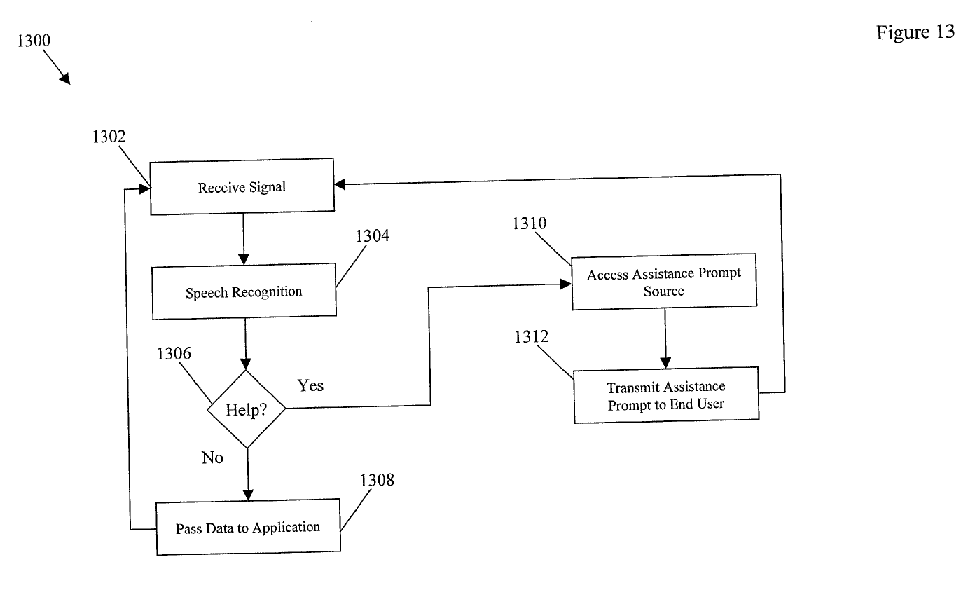

FIG. 13 illustrates an embodiment to provide speech-based assistance during the execution of an application 1300. In this embodiment, when an end user speaks, acoustic word signals that correspond to the sound of the words spoken are received (step 1304). These signals are passed to a speech recognizer that processes these signals into data or one or more commands (step 1304).

The speech recognizer typically includes an acoustic database. This database includes a plurality of words having acoustic patterns for subword units. This acoustic database is used in conjunction with a pronunciation dictionary to determine the acoustic patterns of the words in the dictionary. Also included with the speech recognizer are one or more grammars, a language model associated with each grammar, and the pronunciation dictionary, all created as described above.

During speech recognition, when an end user speaks, acoustic word signals that correspond to the sound of the words spoken are received and digitized. Typically, a speech recognizer compares the acoustic word signals with the acoustic patterns in the acoustic database. An acoustic score based at least in part on this comparison is then calculated. The acoustic score is a measure of how well the incoming signal matches the acoustic models that correspond to the word in question. The acoustic score is calculated using a hidden Markov model of triphones. (Triphones are phonemes in the context of surrounding phonemes, e.g., the word “one” can be represented as the phonemes “w ah n”. If the word “one” was said in isolation (i.e., just with silence around it), then the “w” phoneme would have a left context of silence and a right context of the ah phoneme, etc. The triphones to be scored are determined at least in part by word pronunciations.

Next, a word sequence score is calculated. The word sequence score is based at least in part on the acoustic score and a language model score. The language model score is a measure of how well the word sequence matches word sequences predicted by the language model. The language model score is based at least in part on a standard statistical n-gram (e.g., bigram or trigram) backoff language model (or set of such models). The language model score represents the score of a particular word given the one or two words that were recognized before (or after) the word in question. In response to this word sequence score, one or more hypothesized word sequences are then generated. The hypothesized word sequences include words and phrases that potentially represent what the end user has spoken. One hypothesized word sequence typically has an optimum word sequence score that suggests the best match between the sequence and the spoken words. Such a sequence is defined as the optimum hypothesized word sequence.

The optimum hypothesized word sequence, or several other hypothesized word sequences with favorable word sequence scores, are handed to the parser. The parser attempts to match a grammar against the word sequence. The grammar includes the original and generalized examples, generated as described above. The matching process ignores spoken words that do not occur in the grammar; these are termed “unknown words.” The parser also allows portions of the grammar to be reused. The parser scores each match, preferring matches that account for as much of the sequence as possible. The collection of variable values given by subgrammars included in the parse with the most favorable score is returned to the application program for processing.

As discussed above, recognition capabilities can be expanded when the values corresponding to a variable are part of a restricted set. Nevertheless, in some instances the values present in the restricted set are not known until runtime. To contend with this, an alternative embodiment generates a flat grammar at runtime using the then-available values and steps similar to those described above. This flat grammar is then included in the grammar provided at the start of speech recognition (step 1304).

The content of the recognized speech (as well as other signals received from the end user, such as DTMF tones) can indicate whether the end user needs speech-based assistance (step 1306). If speech-based assistance is not needed, the data associated with the recognized speech are passed to the application (step 1308). Conversely, speech-based assistance can be indicated by, for example, the end user explicitly requesting help by saying “help.” As an alternative, the developer can construct the application to detect when the end user is experiencing difficulty providing a response. This could be indicated by, for example, one or more instances where the end user fails to respond, or fails to respond with recognizable speech. In either case, help is appropriate and a system according to the invention then accesses a source of assistance prompts (step 1310). These prompts are based on the example user response phrase, or a grammar, or both. To illustrate, an example user response phrase can be played to the end user to demonstrate the proper form of a response. Further, other phrases can also be generated using the grammar, as needed, at application runtime and played to guide the end user.

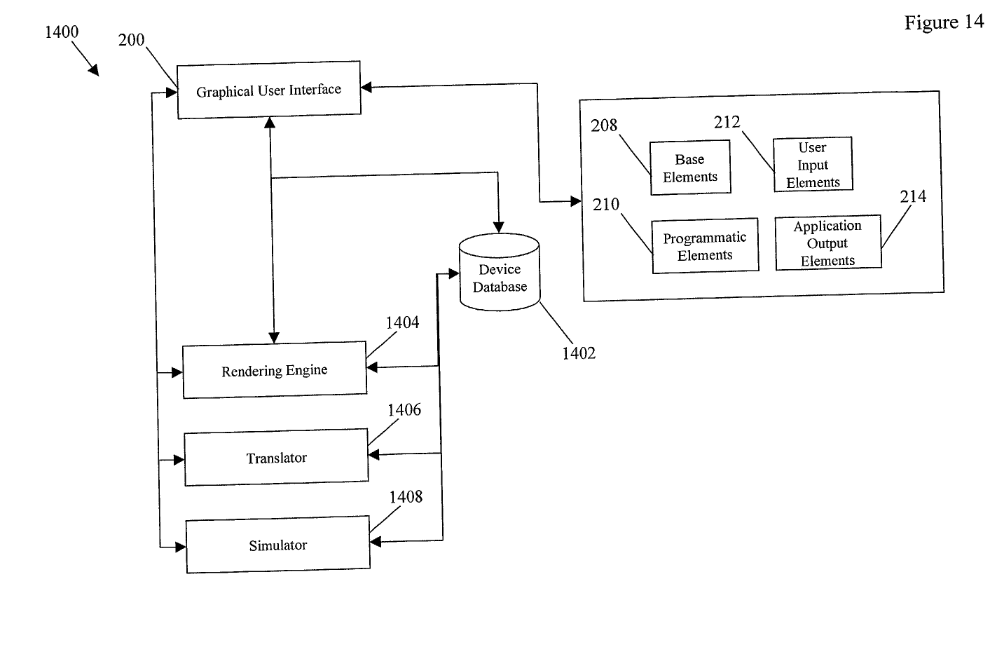

Referring to FIG. 14, in a further embodiment the invention provides a visual programming apparatus 1400 that includes a target device database 1402. The target device database 1402 contains the profile of, and other information related to, each device listed in the device pane 206. The capability parameters are generally included in the target device database 1402. The apparatus 1400 also includes the graphical user interface 200 and the plurality of program elements, both discussed above in detail. Note that the program elements include the base elements 208, programmatic elements 210, user input elements 212, and application output elements 214.

To display a representation of the target devices on the graphical user interface 200, a rendering engine 1404 is provided. The rendering engine 1404 typically communicates with the target device database 1402 and includes both the hardware and software needed to generate the appropriate images on the graphical user interface 200. A graphics card and associated driver software are typical items included in the rendering engine 1404.

A translator 1406 examines the MTML code associated with each program element that the developer has chosen. The translator 1406 also interrogates the target device database 1402 to ascertain information related to the target devices and categories the developer has selected in the device pane 206. Using the information obtained from the target device database 1402, the translator 1406 creates appropriate layout elements in the layout file 1024 and establishes links between them and the source code file 1022. These links ensure that, at runtime, the application will appear properly on each target device and category the developer has selected. These links are unique within a specific document because the tag name of an MTML element is concatenated with a unique number formed by sequentially incrementing a counter for each distinct MTML element in the source code file 1022.

For the developer to appreciate the appearance of the software application on each target device, and debug the application as needed, at least one simulator 1408 is provided. The simulator 1408 communicates with the target device database 1402 and the graphical user interface 200. As the developer creates the application, the simulator 1408 determines how each selected target device will display that application and presents the results on the graphical user interface 200. The simulator 1408 performs this determination is in real time, so the developer can see the effects of changes made to the application as those changes are being made.

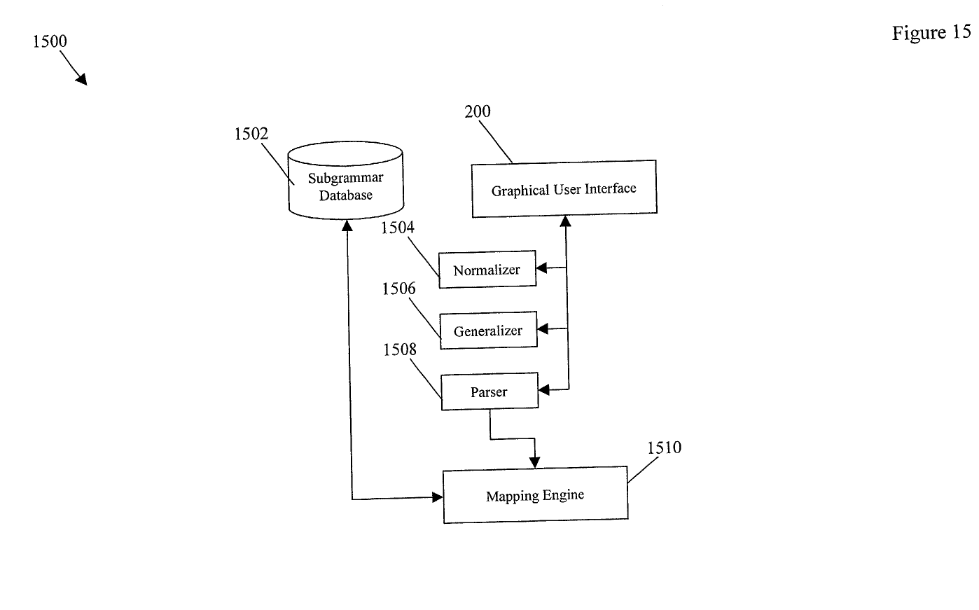

As shown in FIG. 15, an embodiment of the invention features a natural language grammar generator 1500. Using the graphical user interface 200, the developer provides the example user response phrases. A normalizer 1504, communicating with the graphical user interface 200, operates on these phrases to standardize orthographic items such as spelling, capitalization, acronyms, date formats, and numerals. For example, the normalizer 1504 ensures words such as “Wednesday” and “wednesday” are treated as the same word. Other examples include ensuring “January 5^{th}” means the same thing as “january fifth” or “⅕”. In such instances, the variants are normalized to the same representation. A generalizer 1506 also communicates with the graphical user interface 200 and creates additional example user response phrases. The developer can influence the number and nature of these additional phrases.

A parser 1508 is provided to examine each example user response phrase and assist with the identification of at least one variable therein. A mapping apparatus 1510 communicates with the parser 1508 and a subgrammar database 1502. The subgrammar database 1502 includes one or more subgrammars that can be associated with each variable by the mapping apparatus 1510.

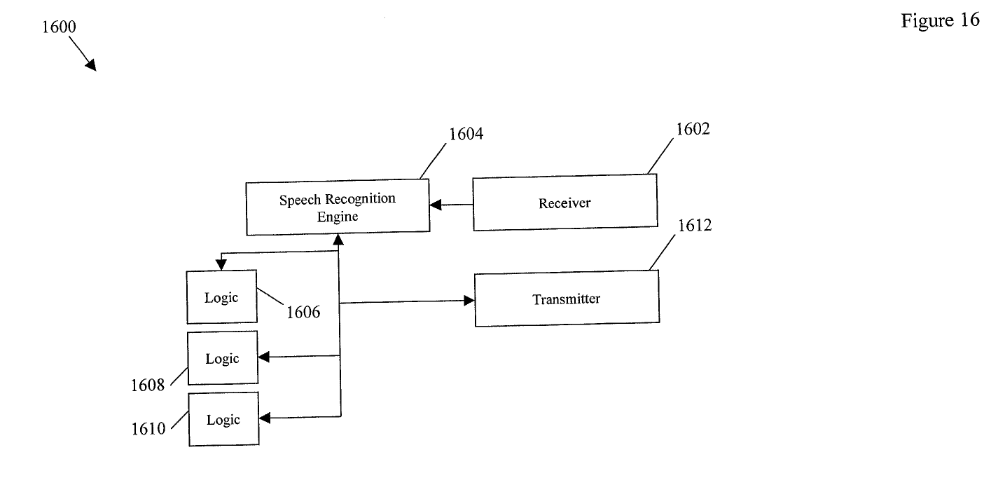

As shown in FIG. 16, one embodiment of the invention features a speech-based assistance generator 1600. The speech-based assistance generator 1600 includes a receiver 1602 and a speech recognition engine 1604 that processes acoustic signals received by the receiver 1602. Logic 1606 determines from the processed signal whether speech-based assistance is appropriate. For example, the end user may explicitly ask for help or interact with the application in such a way as to suggest that help is needed. The logic 1606 detects such instances. To provide the assistance, logic 1608 accesses one or more example user response phrases (as provided by the developer) and logic 1610 accesses one or more grammars. The example user response phrase, a phrase generated in response to the grammar, or both, are transmitted to the end user using a transmitter 1612. These serve as prompts and are played for the user to demonstrate an expected form of a response.

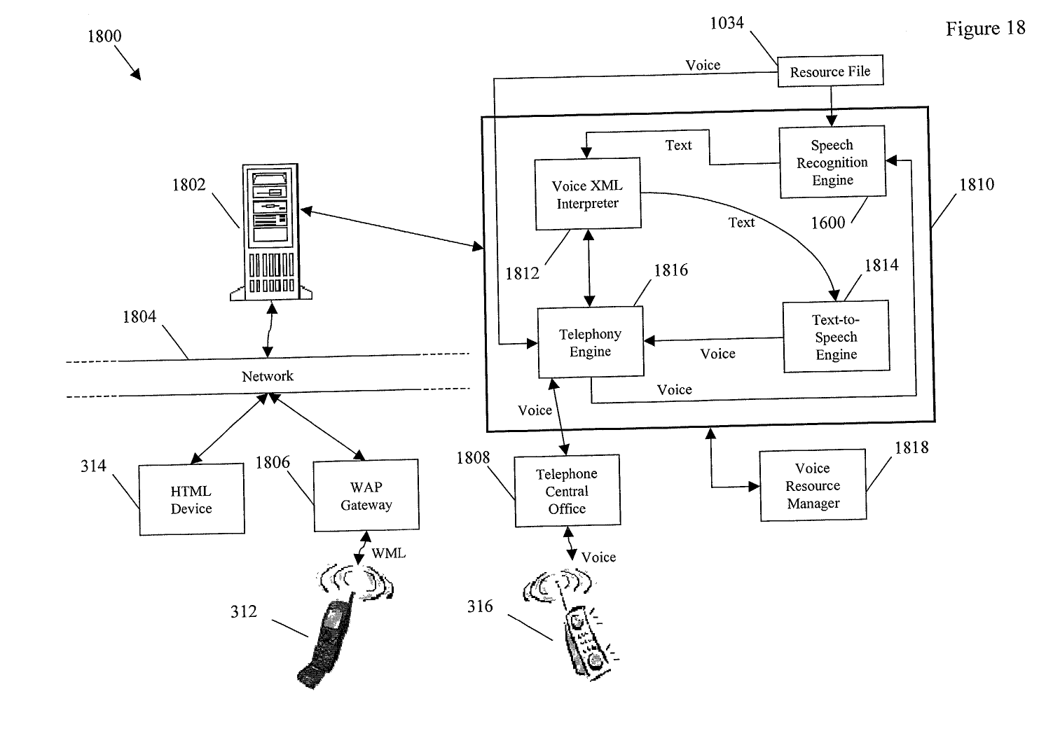

As shown in FIG. 18, the application produced by the developer typically resides on a server 1802 that is connected to a network 1804, such as the Internet. By using a system according to the invention, the resulting application is one that is accessible to many different types of client platforms. These include the HTML device 314, the WML device 312, and the VoiceXML device 316. The WML device 312 typically accesses the application through a Wireless Application Protocol (“WAP”) gateway 1806. The VoiceXML device 316 typically accesses the application through a telephone central office 1808.

In one embodiment, a voice browser 1810, under the operation and control of a voice resource manager 1818, includes various speech-related modules that perform the functions associated with speech-based interaction with the application. One such module is the speech recognition engine 1600 described above that receives voice signals from a telephony engine 1816. The telephony engine 1816 also communicates with a VoiceXML interpreter 1812, a text-to-speech engine 1814, and the resource file 1034. The telephony engine 1816 sends and receives audio information, such as voice, to and from the telephone central office 1808. The telephone central office 1808 in turn communicates with the VoiceXML device 316. To interact with the application, an end user speaks and listens using the VoiceXML device 316.

The text-to-speech engine 1814 translates textual matter associated with the application, such as prompts for inputs, in to spoken words. These spoken words, as well as resources included in the resource file 1034 as described above, are passed to the telephone central office 1808 via the telephony engine 1816. The telephone central office 1808 sends these spoken words to the end user, who hears them on the VoiceXML device 316. The end user responds by speaking in to the VoiceXML device 316. What is spoken by the end user is received by the telephone central office 1808, passed to the telephony engine 1816, and processed by the speech recognition engine 1600. The speech recognition engine 1600 communicates with the resource file 1034 and converts the recognized speech in to text and passes the text to the application for action.

The VoiceXML interpreter 1812 integrates telephony, speech recognition, and text-to-speech technologies. The VoiceXML interpreter 1812 provides a robust, scalable implementation platform which optimizes runtime speech performance. It accesses the speech recognition engine 1600, passes data, and retrieves results and statistics.

The voice browser 1810 need not be resident on the server 1802. An alternative within the scope of the invention features locating the voice browser 1810 on another server or host that is accessible using the network 1804. This allows, for example, a centralized entity to manage the functions associated with the speech-based interaction with several different applications. In one embodiment, the centralized entity is an Application Service Provider (hereinafter, “ASP”) that provides speech-related capability for a variety of applications. The ASP can also provide application development, hosting and backup services.

Note that because FIGS. 10, 14, 15, 16, and 18 are block diagrams, the enumerated items are shown as individual elements. In actual implementations of the invention, however, they may be inseparable components of other electronic devices such as a digital computer. Thus, actions described above may be implemented in software that may be embodied in an article of manufacture that includes a program storage medium.

From the foregoing, it will be appreciated that the methods provided by the invention afford a simple and effective way to develop software applications that end users can access and interact with by using speech. The problem of reduced or no access due to the limited capabilities of certain client devices is largely eliminated.

One skilled in the art will realize the invention may be embodied in other specific forms without departing from the spirit or essential characteristics thereof. The foregoing embodiments are therefore to be considered in all respects illustrative rather than limiting of the invention described herein. The scope of the invention is not limited only to the foregoing description.

What is claimed is:

1. A method of creating a software application, the method comprising the steps of:
accepting a selection of a plurality of target devices;
determining capability parameters for each target device;
rendering a representation of each target device on a graphical user interface;
receiving input from a developer creating the software application;
simulating, in substantially real time and in response to the input, at least a portion of the software application on each target device; and
displaying a result of the simulation on the graphical user interface.

2. The method of claim 1 further comprising the steps of:
defining at least one page of the software application;
associating at least one program element with the at least one page, the at least one program element including a corresponding markup code;
storing the corresponding markup code; and
adapting, in response to the capability parameters, the corresponding markup code to each target device substantially simultaneously.

3. The method of claim 2 wherein the corresponding markup code comprises MTML code.

4. The method of claim 2 further comprising the steps of:
defining content ancillary to the software application; and
associating the ancillary content with the at least one program element.

5. The method of claim 4 wherein the step of defining ancillary content further comprises the steps of:
generating a content source identification file;
generating a request schema;
generating a response schema; and
generating a sample data file.

6. The method of claim 5 further comprising the step of generating a request transform and a response transform.

7. The method of claim 2 wherein the at least one page of the software application comprises at least one of a setup section, a completion section, and a form section.

8. The method of claim 2 further comprising the step of associating Java-based code with the at least one page.

9. The method of claim 2 further comprising the step of associating at least one resource with the at least one program element, wherein the at least one resource comprises at least one of a text prompt, an audio file, a natural language grammar file, and a graphic image.

10. The method of claim 2 wherein the rendering step further comprises displaying a voice conversation template in response to the at least one program element.

11. The method of claim 10 further comprising the step of accepting changes to the voice conversation template.

12. The method of claim 2 further comprising the steps of:
transferring an application definition file to a repository; and
creating, in response to the application definition file, at least one of a Java server page, an XSL style sheet, and an XML file, wherein the Java server page includes software code to (i) identify a client device, (ii) invoke at least a portion of the XSL style sheet, (iii) generate a client-side markup code, and (iv) transmit the client-side markup code to the client device.

13. The method of claim 12 wherein the client-side markup code comprises at least one of WML code, HTML code, and VoiceXML code.

14. The method of claim 12 wherein the application definition file comprises at least one of a source code file, a layout file, and a resource file.

15. The method of claim 12 wherein the step of transferring an application definition file is accomplished using a standard protocol.

16. The method of claim 12 further comprising the step of creating at least one static page in a predetermined format.

17. The method of claim 16 wherein the predetermined format comprises the PQA format.

18. A visual programming apparatus for creating a software application for a plurality of target devices, the visual programming system comprising:
a target device database for storing device-specific profile information;
a graphical user interface that is responsive to input from a developer;
a plurality of program elements for constructing the software application, each program element including corresponding markup code;
a rendering engine in communication with the graphical user interface and the target device database for displaying a representation of the target devices;
a translator in communication with the graphical user interface and the target device database for creating at least one layout element in at least one layout file and linking the corresponding markup code to the at least one layout element; and
at least one simulator in communication with the graphical user interface and the target device database for simulation of at least a portion of the software application and displaying the results of the simulation on the graphical user interface.

19. An article of manufacture comprising a program storage medium having computer readable program code embodied therein for causing the creation of a software application, the computer readable program code in the article of manufacture including:
computer readable code for causing a computer to accept a selection of a plurality of target devices;
computer readable code for causing a computer to determine capability parameters for each target device;
computer readable code for causing a computer to render a representation of each target device on a graphical user interface;
computer readable code for causing a computer to define at least one page of the software application;
computer readable code for causing a computer to associate at least one program element with the at least one page, the at least one program element including a corresponding markup code;
computer readable code for causing a computer to store the corresponding markup code;
computer readable code for causing a computer to adapt, in response to the capability parameters, the corresponding markup code to each target device substantially simultaneously;
computer readable code for causing a computer to simulate, in substantially real time and in response to the capability parameters and the at least one program element, at least a portion of the software application on each target device; and
computer readable code for causing a computer to display a result of the simulation on the graphical user interface, so as to achieve the creation of a software application.

20. A program storage medium readable by a computer, tangibly embodying a program of instructions executable by the computer to perform method steps for creating a software application, the method steps comprising:
accepting a selection of a plurality of target devices;
determining capability parameters for each target device;
rendering a representation of each target device on a graphical user interface;
defining at least one page of the software application;
associating at least one program element with the at least one page, the at least one program element including a corresponding markup code;
storing the corresponding markup code;
adapting, in response to the capability parameters, the corresponding markup code to each target device substantially simultaneously;
simulating, in substantially real time and in response to the capability parameters and the at least one program element, at least a portion of the software application on each target device; and
displaying a result of the simulation on the graphical user interface, so as to achieve the creation of a software application.

21. A method of creating a natural language grammar, the method comprising the steps of:
accepting at least one example user response phrase appropriately responsive to a specific query;
identifying at least one variable in the at least one example user response phrase, the at least one variable having a corresponding value;
specifying a data type for the at least one variable;
associating a subgrammar with the at least one variable;
replacing a portion of the at least one example user response phrase, the portion including the at least one variable, with a reference to the subgrammar; and
defining a computation to be performed by the subgrammar, the computation providing the corresponding value of the at least one variable.

22. The method of claim 21, wherein the step of identifying at least one variable further comprises the steps of:
selecting a segment of the example user response phrase, the segment including the at least one variable; and
copying the segment of the example user response phrase to a grammar template.

23. The method of claim 21, wherein the step of identifying at least one variable further comprises the steps of:
entering the corresponding value of the at least one variable; and
parsing the at least one example user response phrase to locate the at least one variable capable of having the corresponding value.

24. The method of claim 21 further comprising the step of normalizing the at least one example user response phrase.

25. The method of claim 21 further comprising the step of specifying a desired degree of generalization.

26. The method of claim 21 further comprising the steps of:
determining whether the corresponding value is restricted to a set of values and, if so restricted:
generating a subset of phrases associated with the set of values;
removing from the subset of phrases those phrases deemed not sufficiently specific; and
creating at least one flat grammar based at least in part on each remaining phrase in the subset.

27. The method of claim 26 wherein the subgrammar comprises the flat grammar.

28. The method of claim 21 further comprising the step of creating a language model based at least in part on words in the at least one example user response phrase.

29. The method of claim 21 further comprising the step of creating a pronunciation dictionary based at least in part on the at least one example user response phrase, the pronunciation dictionary including at least one pronunciation for each word therein.

30. A natural language grammar generator comprising:
a graphical user interface that is responsive to input from a developer, the input including at least one example user response phrase;
a subgrammar database for storing subgrammars to be associated with the at least one example user response phrase;
a normalizer in communication with the graphical user interface for standardizing orthography in the at least one example user response phrase;
a generalizer in communication with the graphical user interface for operating on the at least one example user response phrase to create at least one additional example user response phrase;
a parser in communication with the graphical user interface for operating on the at least one example user response phrase and identifying at least one variable therein; and
a mapping apparatus in communication with the parser and the subgrammar database for associating the at least one variable with at least one subgrammar.

31. An article of manufacture comprising a program storage medium having computer readable program code embodied therein for causing the creation of a natural language grammar, the computer readable program code in the article of manufacture including:
computer readable code for causing a computer to accept at least one example user response phrase appropriately responsive to a specific query;
computer readable code for causing a computer to identify at least one variable in the at least one example user response phrase, the at least one variable having a corresponding value;
computer readable code for causing a computer to specify a data type for the at least one variable;
computer readable code for causing a computer to associate a subgrammar with the at least one variable;
computer readable code for causing a computer to replace a portion of the at least one example user response phrase, the portion including the at least one variable, with a reference to the subgrammar; and
computer readable code for causing a computer to define a computation to be performed by the subgrammar, the computation providing the corresponding value of the at least one variable, so as to achieve the creation of a natural language grammar.

32. A program storage medium readable by a computer, tangibly embodying a program of instructions executable by the computer to perform method steps for creating a natural language grammar, the method steps comprising:
accepting at least one example user response phrase appropriately responsive to a specific query;
identifying at least one variable in the at least one example user response phrase, the at least one variable having a corresponding value;
specifying a data type for the at least one variable;
associating a subgrammar with the at least one variable;
replacing a portion of the at least one example user response phrase, the portion including the at least one variable, with a reference to the subgrammar; and
defining a computation to be performed by the subgrammar, the computation providing the corresponding value of the at least one variable, so as to achieve the creation of a natural language grammar.

33. A method of providing speech-based assistance during execution of an application, the method comprising the steps of:
receiving a signal from an end user;
processing the signal using a speech recognizer; and
determining, from the processed signal, whether speech-based assistance is appropriate and, if appropriate, (i) accessing at least one of an example user response phrase and a grammar, and (ii) transmitting, to the end user, at least one assistance prompt, wherein the at least one assistance prompt is the example user response phrase, or a phrase generated in response to the grammar.

34. A method of creating a dynamic grammar, the method comprising the steps of:
determining, at application runtime, whether a value corresponding to at least one variable, the at least one variable included in at least one example user response phrase, is restricted to a set of values and, if so restricted:
generating a subset of phrases associated with the set of values;
removing from the subset of phrases those phrases deemed not sufficiently specific;
creating at least one flat grammar based at least in part on each remaining phrase in the subset;
creating at least one language model corresponding to the at least one flat grammar; and
creating at least one pronunciation dictionary corresponding to the at least one flat grammar.

35. A speech-based assistance generator comprising:
a receiver for receiving a signal from an end user;
a speech recognition engine for processing the signal, the speech recognition engine in communication with the receiver;
logic that determines from the processed signal whether speech-based assistance is appropriate;
logic that accesses at least one example user response phrase;
logic that accesses at least one grammar; and
a transmitter for sending to the end user at least one assistance prompt, wherein the at least one assistance prompt is the at least one example user response phrase, or a phrase generated in response to the grammar.

36. An article of manufacture comprising a program storage medium having computer readable program code embodied therein for providing speech-based assistance during execution of an application, the computer readable program code in the article of manufacture including:
computer readable code for causing a computer to receive a signal from an end user;
computer readable code for causing a computer to process the signal using a speech recognizer; and
computer readable code for causing a computer to determine, from the processed signal, whether speech-based assistance is appropriate and, if appropriate, causing a computer to (i) access at least one of an example user response phrase and a grammar, and (ii) transmit, to the end user, at least one assistance prompt, wherein the at least one assistance prompt is the example user response phrase, or a phrase generated in response to the grammar, so as to provide speech-based assistance.

37. A program storage medium readable by a computer, tangibly embodying a program of instructions executable by the computer to perform method steps for providing speech-based assistance, the method steps comprising:
receiving a signal from an end user;
processing the signal using a speech recognizer;
determining, from the processed signal, whether speech-based assistance is appropriate and, if appropriate, (i) accessing at least one of an example user response phrase and a grammar, and (ii) transmitting, to the end user, at least one assistance prompt, wherein the at least one assistance prompt is the example user response phrase, or a phrase generated in response to the grammar, so as to provide speech-based assistance.
